(19) United States
(12) Patent Application Publication
(10) Pub. No.: US 2005/0029175 A1
(43) Pub. Date: Feb. 10, 2005

(54) System and a method for removing support material from a solid freeform fabricated article

(76) Inventors: Isaac Farr, Corvallis, OR (US); Shawn D. Hunter, Corvallis, OR (US)

Correspondence Address: HEWLETT-PACKARD COMPANY;Intellectual Property Administration, P.O. Box 272400, Fort Collins, CO, 80527-2400, US

(21) Appl. No.: 10/638,003

(22) Filed: Aug. 8, 2003

(51) Int. Cl. B01D 21/30

(52) U.S. Cl. 210/143

(57) ABSTRACT

A system for separating materials of differing melting points includes an ultrasonic bath with a solution configured to remove a meltable material by cavitation, and an emulsifier disposed in the solution, wherein the emulsifier is configured to solubilize the meltable material thereby extending a useable life of the solution.

### BACKGROUND

Solid freeform fabrication (SFF) is a process whereby three-dimensional objects, for example, prototype parts, models, working tools, production parts, molds, and other articles are manufactured. Computer aided design (CAD) is commonly used to automate the design process. Using a suitable computer, an operator may design a three-dimensional article and then create that object by the use of a positionable ejection head that selectively emits small mass particles. Many methods have been developed to manufacture SFF objects according to the above principles including stereolithography, selective laser sintering, and powder based three-dimensional printing technologies. The above-mentioned techniques typically include support structures designed to join the SFF object to a system platform and attach any overhangs, large spans, or disjoint areas. The addition of these structures to the CAD model and subsequent manual removal from the SFF article during cleaning is labor intensive and often requires special skills, significantly increasing the cost of fabrication.

One traditional method for forming three-dimensional objects includes a device having two positionable jetting heads with two feeder lines connected to remote sources of material such as melted wax to provide both object and support material. This method and apparatus are able to construct an object from a coordinate representation without regard to the angular dimensions thereof by automatically depositing support material wherever needed to support the build material. In this way, the user need not add support structures to the CAD model; software automatically adds support material wherever needed. One common method uses different waxes having varying melting temperatures for the build and support materials, with the support wax having a lower melting point than the build wax. While this traditional method allows the undesirable support material to be melted away, traditional processes used to clean such SFF articles with phase change support are time consuming, may utilize a hydrocarbon or other organic solvent (which may be noxious), are manual (requiring skilled labor), tedious, and expensive. Traditional cleaning processes may also leave an undesirable waxy support material residue on the surface of the SFF object.

### SUMMARY

A system for separating materials of differing melting points includes an ultrasonic bath with a solution configured to remove a meltable material by cavitation, and an emulsifier disposed in the solution, wherein the emulsifier is configured to solubilize the meltable material thereby extending a useable life of the solution.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention. The summary and other features and aspects of the present invention will become further apparent upon reading the following detailed description and upon reference to the drawings in which:

FIG. 1 is a perspective view of a solid freeform fabrication (SFF) system that may incorporate the present system and method according to one exemplary embodiment.

FIG. 2 is a perspective view of an SFF system fabricating an SFF article according to one exemplary embodiment.

FIG. 3 is a schematic representation of a system for removing support material from previously fabricated SFF articles according to one exemplary embodiment.

FIG. 4a is a side view of an example SFF article after fabrication, including both build and support material, before being subjected to a cleaning procedure according to one exemplary embodiment.

FIG. 4b is a cross sectional view of an example SFF article according to one exemplary embodiment.

FIG. 5 illustrates an SFF article submerged in a hot water bath with a majority of the support material melted off the SFF article according to one exemplary embodiment.

FIG. 6 is a representation of an SFF article submerged in the hot water bath of FIG. 3 before ultrasonic scrubbing according to one exemplary embodiment.

FIG. 7 is a drawing of the SFF article undergoing an ultrasonic cleaning process according to one exemplary embodiment.

FIG. 8 is a representation of the SFF article after completion of the cleaning process in the apparatus of FIG. 3 according to one exemplary embodiment.

FIG. 9 is a flowchart illustrating a method of operating the system illustrated in FIG. 3 according to one exemplary embodiment.

Throughout the drawings, identical reference numbers designate similar, but not necessarily identical, elements.

### DETAILED DESCRIPTION

The present specification describes a system and method for automating the removal of meltable support material from solid freeform fabrication articles while reducing the time and cost of the support material removal process. Moreover, the present system and method is sufficiently quiet, compact, and environmentally friendly to enable usage in non-industrial environments. The present system and method are not limited to objects manufactured by SFF, rather they may also be used to remove meltable support material from any object consisting of two materials having different melting temperatures.

As used in this specification and in the appended claims, the term “meltable” is meant to be understood broadly as describing any support material having a lower melting point than a solid freeform fabrication build material. The term “emulsifier” refers to a surface active agent (surfactant) used to stabilize a mixture of immiscible or insoluble materials. Similarly, an “emulsion” is meant to be understood as any uniform mixture of two immiscible liquids stabilized by the presence of an emulsifier. A “skimmer” is meant to be understood as any device or method that may be used to remove melted support material from a liquid, and may include, but is in no way limited to, a belt, a disk, a drum, a mop, a tube, a floating suction, a columnar, a co-current, a counter current, a venturi technology skimmer, or any combination of these or other skimmer technologies. Moreover, a manual technique for removing melted support material may also constitute a skimmer for the purposes of this disclosure. The terms “ultrasonic cleaning” and “ultrasonic scrubbing” are used to denote a method of removing waxy surface residue from solid freeform fabrication (SFF) articles by means of small bubbles (cavitation bubbles) produced by high frequency waves. The bubbles' sequential formation and subsequent violent collapse (cavitation) may remove contaminants from an SFF build-material's surface. “Ultrasonics” is meant to be understood as any transducer or device used to induce cavitation in a hot water bath.

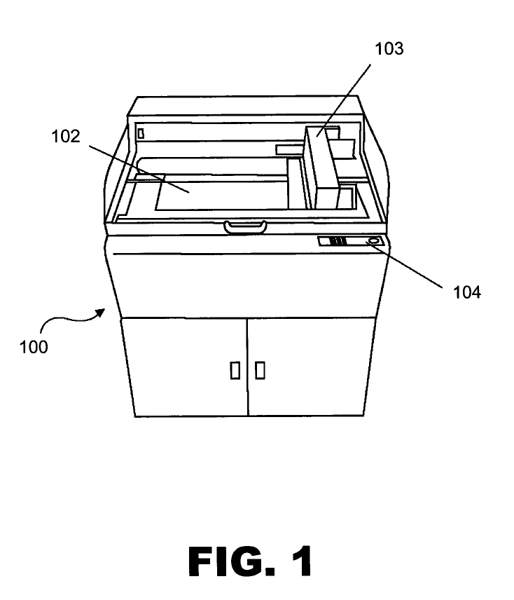

Referring now to the figures and in particular to FIG. 1, a solid freeform fabrication (SFF) system (100) configured to incorporate particle deposition technology is described. The SFF system (100) illustrated in FIG. 1 may also be configured to incorporate the present cleaning system and method. As previously noted, a polymer jetting system or any other similarly operated system may be substituted in place of the SFF system (100) and may be used in conjunction with the present cleaning system.

In the solid freeform fabrication system (100) illustrated in FIG. 1, both build and support materials may be deposited upon a fabrication stage (102) to form individual layers of a desired object. A moving carriage (103) may position the jetting heads, which may then deposit build and/or support materials. A user interface or control panel (104) may also be provided in order to allow the operator to control and monitor the fabrication process.

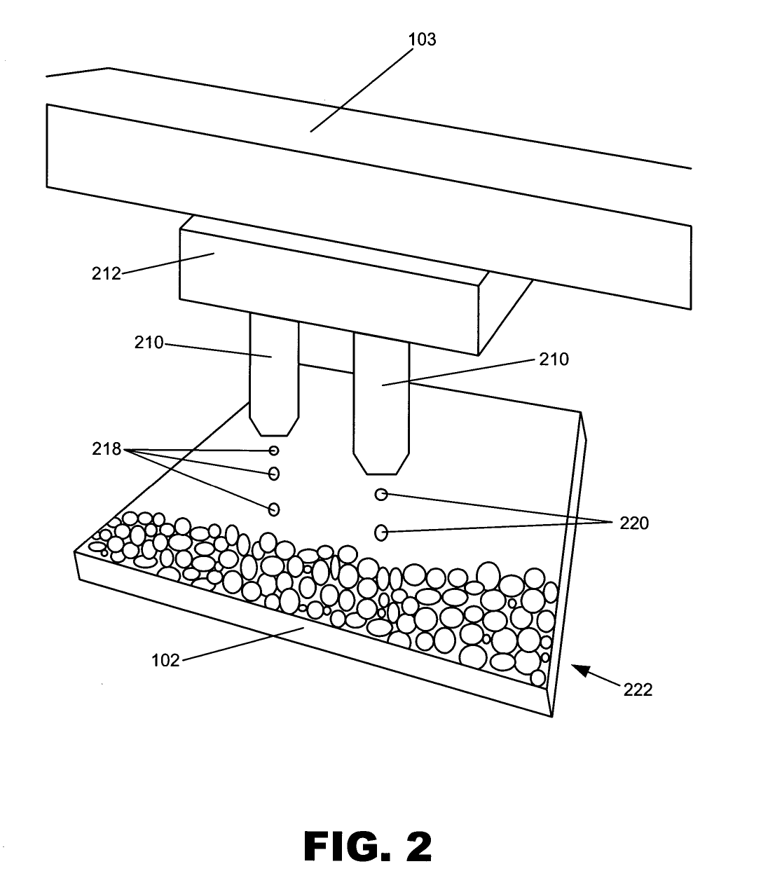

FIG. 2 is a perspective representation of the moving carriage (103), certain undercarriage components, and the fabrication stage (102) in operation. Operation of the SFF system (100; FIG. 1) may incorporate two jetting heads (210): one supplied with build material to form the fabricating particles and at least another with material that may form the support particles. Numerous alternatives to this scheme are also possible. For example, a single jetting head incorporating two feeder lines may be used. In an alternative configuration, a first linear array of fabricating particle jets and a second linear array of support particle jets may be employed. Any number of materials may be used in conjunction with this system; these may include, but are in no way limited to, waxes, plastics, metals, ceramics, and UV curable materials. Alternatively, a binder material may be deposited by a jetting head or heads onto a bed of powder, thereby forming a build material surrounded by an unbound-powder support material. For the purpose of illustration and ease of explanation only, the present system and method will be described in the context of an SFF system (100; FIG. 1) incorporating a two jet system as shown in FIG. 2 and using two waxes with different melting points as build and support materials, respectively.

The jetting head or heads (210) illustrated in FIG. 2 may be coupled by means of suitable electronic and mechanical linkages to one or more servo mechanisms (212), which are responsive to commands issued by a controller (not shown). The controller may be configured to translate coordinates representing a layer of a desired 3-dimensional object design (as compiled by a CAD system) into suitable servo commands to position the fabricating-particle jet above a corresponding position on the fabrication stage (102). The controller may then cause a droplet or droplets (218) of support material to be ejected, which may solidify soon after contact. A complementary set of commands may also be issued by the controller to the build-particle jet, causing it to deposit droplets of build material (220) on positions of the substrate or fabrication stage (102) not occupied by support material. The build materials may also solidify shortly after deposition. Solidification and curing of the deposited droplets may be due to controlled differences in temperature between the particle jet (210) and the build environment, laser sintering, UV or other high energy beam, chemical binding of a resin to a powder, or other appropriate means. After deposition of an initial layer (222), subsequent layers may be similarly formed on top of and in contact with one another forming a desired three-dimensional object.

After a number of layers have been deposited, the structure consisting of fused build particles may be separated from the mass of support particles. The process by which particle separation may be accomplished depends on the choice of material used for each type of particle. According to one exemplary embodiment, the support material may be a phase-change material, which melts at elevated temperatures and has a lower melting point than that of the build material. Traditionally, two different types of wax may be used, the support wax having a lower melting point than the build wax. While practice of the present system and method may be accomplished using any two materials having different melting points, variations of the same material having different melting points, or a non-meltable build material surrounded by meltable support material, for ease of explanation only, the following explanation will be in the context of using build and support materials made of two waxes differing in their respective melting points.

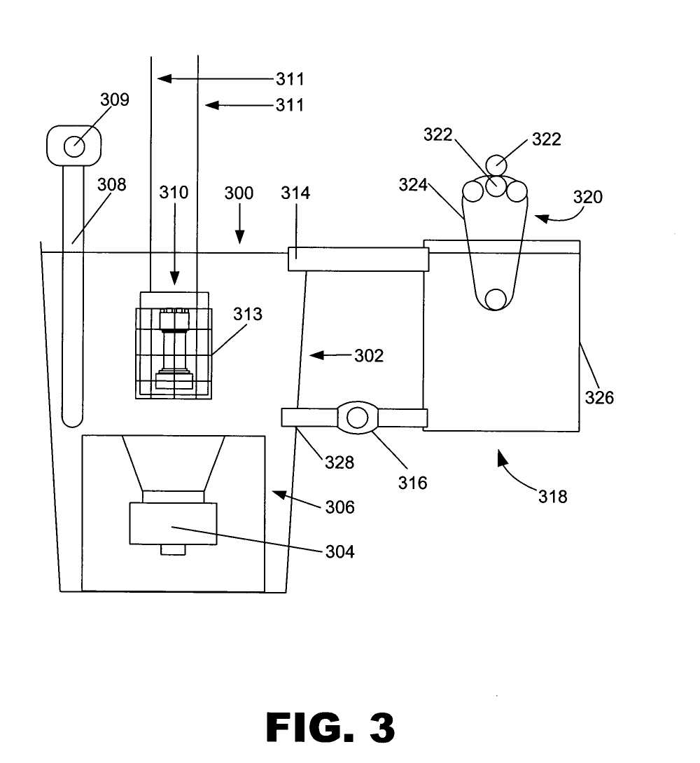

Turning now to FIG. 3, an exemplary embodiment of the present cleaning system is schematically illustrated. An emulsifier solution (300) is shown disposed in an appropriate container, which serves as an ultrasonic tank (302). The emulsifier solution (300) may include one or more emulsifiers configured to emulsify removed material thereby prolonging the useful life of the emulsifier solution (300). The emulsifiers contained in the emulsifier solution may include ionic and/or nonionic surfactants. Useful nonionic surfactants that may be used in the present system include, but are in no way limited to, alkoxylated block polymers, alkoxylated alcohols, alkoxylated alkylphenols, alkoxylated amines, alkoxylated amides, alkoxylated fatty esters, alkoxylated oils, fatty esters, alkoxylated fatty acids, or sorbitan derivatives. Similarly, useful ionic surfactants that may be used by the present system and method include, but are in no way limited to, alkylaryl sulfonates; alkylarylsulfonic acids; carboxylated alcohol ethoxylates and alkylphenol ethoxylates; carboxylic acids/fatty acids; diphenyl sulfonate derivatives; olefin sulfonates; phosphate esters; phosphorus organic derivatives; quaternary surfactants; sulfates and sulfonates of oils and fatty acids; sulfates and sulfonates of ethoxylated alkylphenols; sulfates of ethoxylated alcohols; sulfates of fatty esters; sulfonates of dodecyl and tridecylbenzenes; sulfonates of naphthalene and alkyl naphthalene; sulfonates of petroleum; sulfosuccinamates; alkanolamides; alkoxylated amines; or sarcosine derived surfactants such as ammonium lauroyl sarcosinate.

The emulsifier solution (300) shown in FIG. 3 may or may not be water based: solvents other than water may also be used effectively in conjunction with ultrasonic tanks and heating elements, though they may be flammable and require the use of expensive housings to operate without hazard. While many possible solvents may be used with the following system and method, for ease of explanation only, the following treatment will be described in the context of a hot water/emulsifier solution (300).

The combination of the hot water/emulsifier solution (300) and the ultrasonic tank (302) form a hot water/emulsifier bath capable of applying thermal energy to an SFF article (310) sufficient to remove a substantial majority of support material. While the system of FIG. 3 is illustrated with the ultrasonic tank (302) being filled with a hot water/emulsifier solution (300), the ultrasonic tank may not always be filled with solution. Rather, according to another exemplary embodiment, the support material removal process may begin either in a separate dry oven, or in the ultrasonic tank (302) without the hot water/emulsifier solution (300) present at which time the ultrasonic tank may function as a dry oven. A “dry oven” is meant to be understood as any method of introducing thermal energy to an SFF article without submersing it in a hot bath solution including, but in no way limited to, a steam bath. The present system and method will be described, for ease of explanation only, in the context of a hot water/emulsifier solution (300) configured to apply thermal energy to a desired SFF article (310).

An ultrasonic transducer (304) may be housed in a water-tight enclosure (306) coupled to the ultrasonic tank (302) illustrated in FIG. 3. A resistive element heater (308) or other heating source may also be provided to generate solution temperatures between the melting points of the build and support materials of an SFF article (310). The heater (308) or heating source may be incorporated into the ultrasonic tank (302) itself or it may be physically separate from the ultrasonic tank (302). In an alternative embodiment, the heater (308) may not generate an air and/or solution temperature greater than the melting point of the support material; rather, the heater (308) may merely provide a solution temperature great enough to soften the support material. Heating the support material to a temperature slightly below its melting point may increase the support material's solubility and may soften the support material sufficient to aid in its removal through cavitation or other methods. In either case the heater (308) may be controlled by manual or automatic temperature regulation systems (309). An exemplary SFF article (310), not yet cleaned, including both build and support materials is shown hanging in a wire basket (313) within the ultrasonic tank (302) adjacent to the ultrasonic enclosure (306) in FIG. 3. The wire basket (313) is supported by a number of wires (311). While the article (310) shown in FIG. 3 is a chess piece, any arbitrarily shaped SFF article including build material and meltable support material may be amenable to the cleaning process herein described.

According to the exemplary embodiment shown in FIG. 3, the present system may also include a skimmer system (318). The skimmer system (318) may be any device or method used to remove melted support material from a solution and may include, but is in no way limited to, a belt, a disk, a drum, a mop, a tube, a floating suction, a columnar, a co-current, a counter current, a venturi technology skimmer, or any combination of these or other skimmer technologies. While the skimmer system (320) shown in FIG. 3 is illustrated as a belt skimmer system, any device or method configured to remove a support material from a liquid may similarly be incorporated in the present cleaning method. Even a simple system comprising a waterfall-type solution intake at the surface of the hot water bath, passing through an appropriately chosen filter or filter substrate, and a pump to return the cleaned water/emulsifier solution to the bath may be a skimmer according to the present system and method. Alternatively, any manual method of removing melted support material may also constitute a “skimmer” as used in the present disclosure. The belt skimmer system (318) shown in FIG. 3 may include a solution intake (314) such as an overflow weir, a pump, or any other method of transporting buoyant material in solution near the top of the solution to collect buoyant meltable support material, a reservoir tank (326), a belt skimmer system (320) including a belt (324) and pinch rollers (322), and a solution return (328) including a pump (316). When hot water/emulsifier solution (300) is collected in the reservoir tank (326) through the solution intake (314), impurities in the hot water/emulsifier solution (300) may come in contact with and attach themselves to the belt (324). Once the impurities come into contact with the belt (324), specific gravity and surface tension cause the impurities to attach themselves to the belt. Once on the belt (324), pinch rollers (322) or wiper blades may remove the impurities from the belt (324) thereby cleaning the solution. The skimmed solution may then be pumped by the pump (316) to the bath via the solution return (328).

The cleaning system illustrated in FIG. 3 may also include robotic arms, conveyor belts, rotating baskets, flow controllers, or any other means (not shown) configured to move, rotate, vibrate, or otherwise manipulate the SFF article (310) thereby automating the cleaning process. The automating means may also be used to place the SFF article in the ultrasonic tank, submerge the SFF article (310) in the bath, to subsequently remove it, to remove bubbles from the surface of the article (310), to induce full wetting prior to the activation of the ultrasonics (304), to control the temperature of the oven and/or the solution, control the level of the solution within the ultrasonic tank, or to otherwise automate the cleaning process.

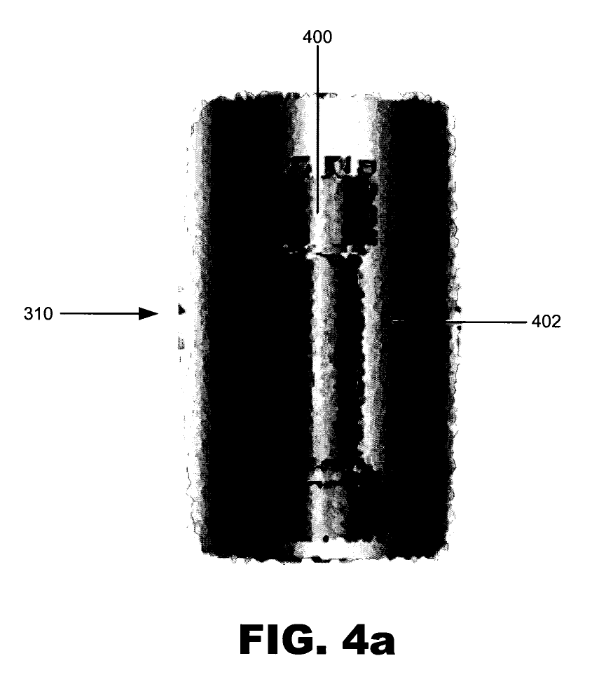

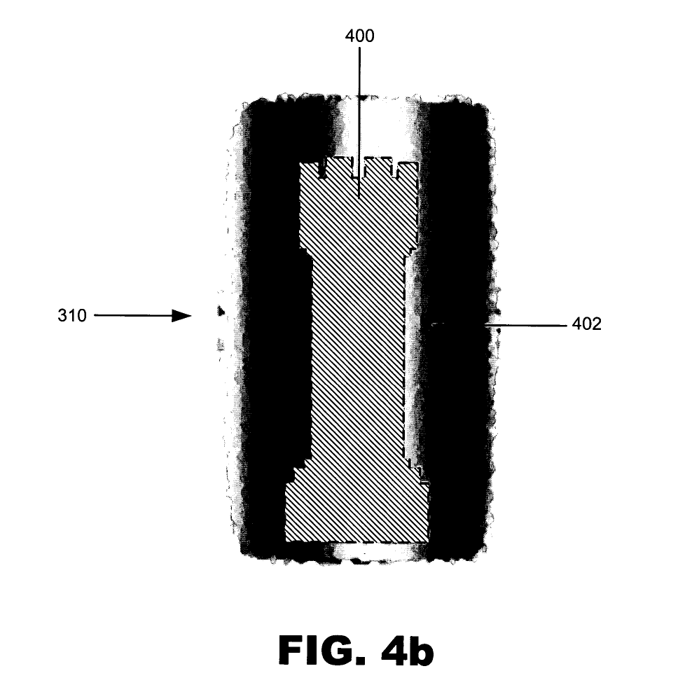

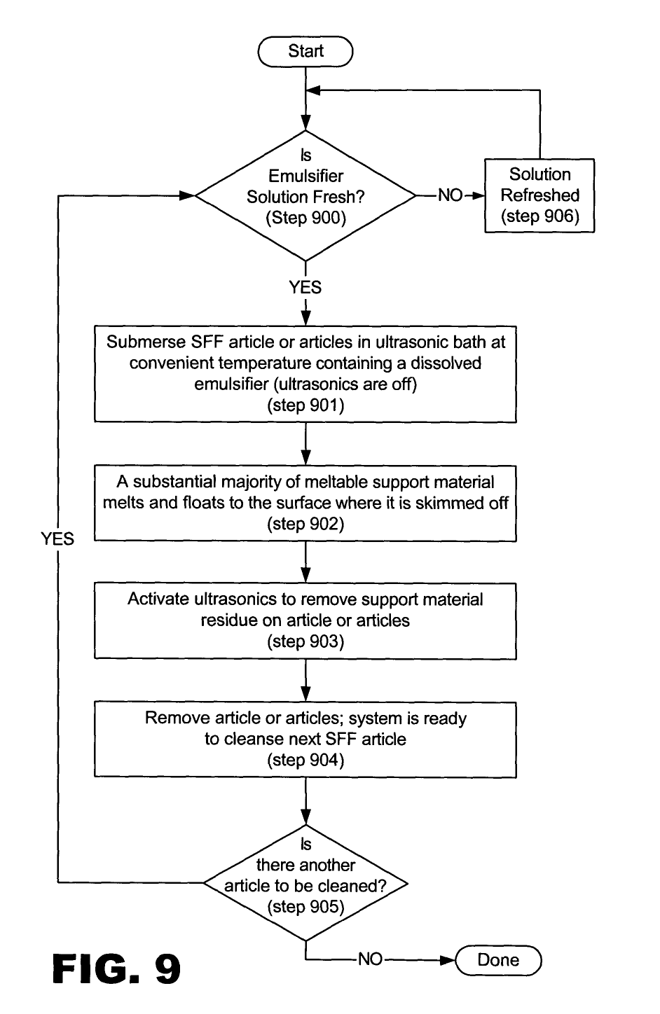

FIGS. 4a-8 depict the SFF example article (310; FIG. 3) during various stages of the cleaning process illustrated in FIG. 9. As FIGS. 4a-8 will be more easily appreciated after consideration of FIG. 9, a brief explanation of FIG. 9 will be given here with a more detailed explanation given hereafter with reference to FIGS. 4a-8. The process illustrated in FIG. 9 begins by first determining whether or not the emulsifier solution (300; FIG. 3) is fresh (step 900); if it is (Yes, step 900), the SFF article (310; FIG. 4a) or articles to be cleaned may be placed inside the ultrasonic tank (302) serving as a heated environment for melting support material. (step 901). A substantial majority of the support material (402; FIG. 4a) may then be melted from the SFF article or articles in this heated environment. Once melted, support material may rise to the surface of the hot water/emulsifier solution (300) due to buoyant forces and may be skimmed off (step 902). The ultrasonics (304; FIG. 3) may then be activated to remove remaining support material residue (step 903), whereupon the SFF article (310; FIG. 4a) or articles, now substantially composed of build material (400; FIG. 4a), may be removed from the cleaning system (step 904). At this point a decision may be made as to whether or not another SFF article (310; FIG. 4a) is to be cleaned; if so, (Yes, step 905), the process repeats from step 900. If not (No, step 905), the process is complete. Moreover, if at any time the solution should be found to have lost its emulsifying properties during a solution check (step 900), the concentration of emulsifiers in the solution may be increased or the ineffective solution may be completely removed and fresh emulsifier solution may be added (step 906).

As shown in FIG. 9, the process may begin with a check of the emulsifier solution (step 900). If the efficacy of the emulsifiers in the hot water/emulsifier solution is determined to be adequate (Yes, step 900), an SFF object (310; FIG. 4b) may be placed in the hot water/emulsifier solution (300; FIG. 3) for processing. FIG. 4a illustrates an example SFF article (310) after a fabrication process has been performed and the article (310) has been placed inside the hot water/emulsifier bath of the present system. As shown in FIG. 4a, the article (310) deposited in the present system may include both build material (400) making up the final SFF object and support material (402) that is to be removed. The build material (400) may be interior to, and surrounded by, the support material (402) in accordance with the operating principles of the SFF system (100; FIG. 1) previously described. Similarly, in the case of an SFF article (310) with a horizontal through-hole or other cavity, support material (402) may be surrounded (locally) by build material (400).

FIG. 4b similarly shows a cross-sectional view of the example SFF article (310). In FIG. 4b, a portion of the support material (402) has been stripped away to illustrate the build material (400) interior to it.

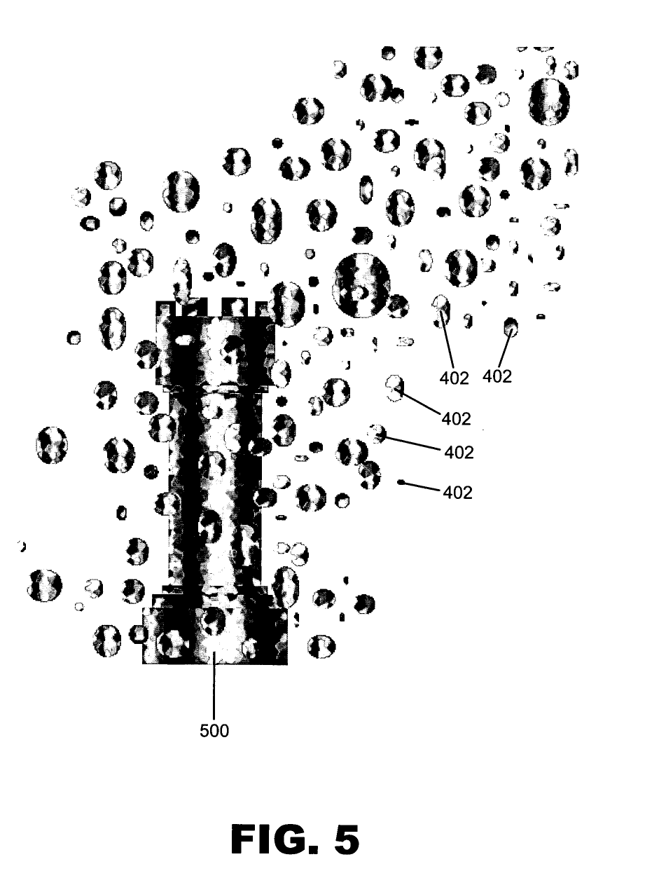

Once the SFF article (310) has been placed in the hot water/emulsifier solution (300; FIG. 3), the temperature of the hot water/emulsifier solution may be raised (or has already been raised) to a convenient temperature between the melting points of the build (400) and support (402) materials, which for the purpose of illustration are considered to be waxes. Under these conditions, a substantial majority of the support material (402) may melt since its melting point is below the operating temperature of the hot water/emulsifier solution (300; FIG. 3). The melted support material may then float to the surface of the hot water/emulsifier solution (300; FIG. 3) as shown in FIG. 5 due to the support material's buoyancy in that medium.

FIG. 5 depicts the SFF article (310; FIG. 4b) with a substantial majority of the support material (402) floating to the surface of the hot water/emulsifier solution (300; FIG. 3) due to its buoyancy in that medium. The size of the material particles present in the hot water/emulsifier solution (300; FIG. 3) may vary and are magnified and shown in FIG. 5 for illustrative purposes only. While this thermal process may remove a majority of the support material, the build material (400; FIG. 4b) may remain coated with a waxy residue (500) of support material after the thermal process. In order to remove this waxy residue (500), ultrasonic energy may be applied.

Once on the surface of the hot water/emulsifier solution (300; FIG. 3), the substantial majority of meltable support material may be removed by a skimming device (step 902; FIG. 9). In the embodiment illustrated in FIG. 3, a belt skimmer (318) provides for removal of the support material (402; FIG. 4b) by skimming it from the surface of the hot water/emulsifier solution (300; FIG. 3). The SFF article may be left to be processed in the hot water/emulsifier bath until a substantial majority of the meltable support material (402; FIG. 4b) has both melted off and been removed from the surface of the hot water/emulsifier bath by skimming (step 902).

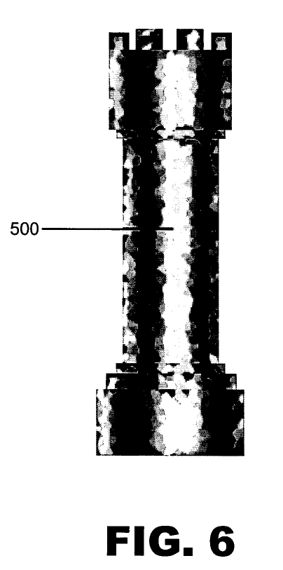

FIG. 6 shows the SFF object (310; FIG. 4b) after a substantial majority of the support material (402; FIG. 4b) has melted away and has been skimmed off the surface of the hot water/emulsifier solution (300; FIG. 3) but before ultrasonics (304; FIG. 3) have been activated. A waxy support material residue (500) may remain, coating the surface of the build material (400; FIG. 4b). The support material residue (500) may adhere to the surface of the build material (400; FIG. 4b) despite operating the present system at a solution temperature greater than the melting point of the support material (402; FIG. 4b) due to surface adhesion forces, especially in corners and small features. Around overhangs or other sharp build material transitions this adhesion effect may be multiplied due to adhesion between support material (402; FIG. 4b) particles themselves and increased build material surface areas, resulting in a thicker support material residue (500) in these areas. The support material residue (500) may also be particularly thick under build material overhangs since support material removal in this system is primarily due to buoyant forces on melted support material being greater than adhesion forces between support material particles and other support material or build material particles. In some cases, part geometries such as overhangs may prevent buoyant forces from carrying the support material away from the SFF object (300; FIG. 3). Various methods, such as agitation, rotation, or directed flow may also be employed to maximize the removal of support material from SFF object geometries.

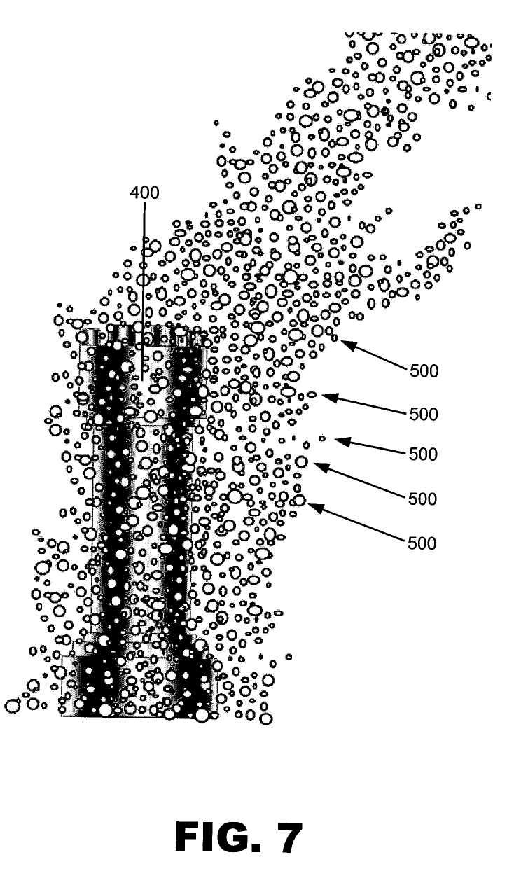

In order to remove this support material residue (500; FIG. 5) an ultrasonic transducer or transducers (304; FIG. 3) may be activated (step 903; FIG. 9) at one or more frequencies in the hot water/emulsifier solution (300; FIG. 3). These ultrasonics induce cavitation through out the bath including near the surface of the SFF build material (400; FIG. 4b) as it is disposed in the hot water/emulsifier bath, thereby removing the remaining support material (402; FIG. 4b) from the build material (400; FIG. 4b) as illustrated in FIG. 7.

As shown in FIG. 7, once the ultrasonics (304; FIG. 3) have been activated the particles forming the waxy residue (500) may be dislodged from the surface of the build material (400; FIG. 4b) by cavitation. Cavitation is the formation and subsequent implosion of bubbles, wherein the violence of the implosion may exhibit sufficient power to overcome particle to substrate adhesion forces and dislodge impurities from the surface of an object. As in FIG. 5, some of the dislodged support material (402; FIG. 5) comprising, in this case, a waxy residue (500) may float to the surface of the hot water/emulsifier solution (300; FIG. 3) due to its buoyancy in that medium and may be drawn into the skimmer intake (314; FIG. 3). However, some of the particles dislodged from the SFF article during cavitation ranging from 50 microns in diameter to 50 nanometers in diameter may remain in the hot water/emulsifier solution near the SFF article. Material particles of this size are difficult to mechanically filter or even detect without special equipment and considerations. If left in the solution, the particles would soon reduce the effectiveness of the solution on subsequent SFF articles. The presence of the emulsifier may cause the hot water/emulsifier solution (300; FIG. 3) near the SFF article (310; FIG. 4b) to remain unsaturated with support material by dispersing the removed particles, thereby prolonging the effectiveness of the ultrasonic scrubbing process for longer periods of time than would otherwise be the case. Again, in actuality the solution may remain largely clear due to the presence of the emulsifier and the support material (402; FIG. 4b), in this case the waxy residue (500) particles, being extraordinarily small. The waxy residue particles are shown in FIG. 7 for illustrative purposes only.

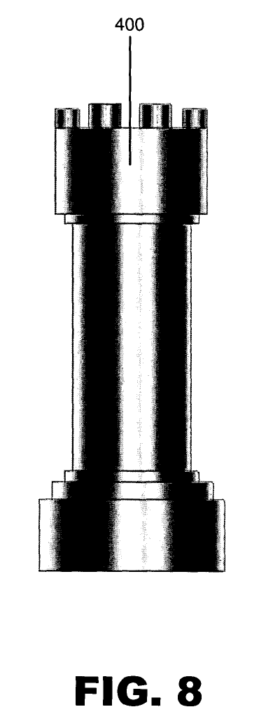

FIG. 8 shows the SFF article (310; FIG. 4b) after the cavitation process has been performed. As shown in FIG. 8, the cavitation process may substantially remove the entire support material residue on the SFF article (310; FIG. 4b).

Returning again to FIG. 9, once the cavitation process has been performed, the cleaned SFF object (310; FIG. 4b) may be removed from the cleaning system (step 904). Again a decision is made, either by an operator or by automatic means, to determine whether another SFF article should be cleaned (step 905). If there is another article to be cleaned (Yes, step 905), the emulsifier solution may again be checked (step 900) and the process may be repeated. If, however, there are no more SFF objects to be cleaned (No, step 905), the process may be terminated. If at any time during a solution check (step 900) the solution (300; FIG. 3) is found to be exhausted of its emulsifying properties (No, step 900), the solution may be disposed of and new cleaning solution added to the system (step 906) or more emulsifier may be added to increase the effectiveness of the water/emulsifier solution. Depending on the skimming technique employed, a skimmer's collection cup or other filter media or collection device may also need to be removed periodically and either washed, emptied, or replaced.

The ultrasonic scrubbing process explained above possesses the advantage of having the ability to remove support material residue from all surfaces of the SFF article including tiny crevices and other places that manual methods are unable to clean. As cavitation efficiency is dependent upon temperature and the presence of surfactants, it is to the advantage of the present system that a surfactant or surfactants are always present in the solution to enhance cavitation. As water cavitates most effectively in the range from 50 degrees to 60 degrees C., it may be advantageous to include an automatic controller or other means to allow the user to raise or lower the temperature of the hot water bath by a few degrees placing the temperature in this effective range while the ultrasonics are turned on. Cavitation may also be tuned using power inputs and performing frequency selection, which may increase cavitation effectiveness. As lower frequency cavitation may produce larger bubbles, cavitation driven at lower frequencies may have greater ability to remove larger particles and particles which are more securely attached to an object's surface. Higher frequency cavitation may conversely produce smaller bubbles, and may be better suited removing support material particles from smaller features, cavities, and severe surface transitions. Consequently, cavitation may be performed at alternating frequencies or simultaneously at multiple frequencies in order to provide the combined benefits of efficient, large scale support material removal while also removing support material minutiae from small features.

Moreover, the present method and system for cleaning SFF parts with meltable support materials requires very little human assistance as described, and is benefited by the possibility of being practiced in a fully automated form, requiring negligible human assistance depending on the specific embodiment. A computing device may be used in conjunction with the system in order to aid in or entirely regulate a decision making process associated with the support material removal process. The computing device may also govern the previously discussed robotic arms, conveyer belts, or other means to move, rotate, vibrate, or otherwise manipulate the SFF article in order to more fully automate the cleaning process. The cleaning system and method may well be incorporated into the SFF system (100) itself, or may be housed separately. Additionally, the system and method may be closed-loop and self contained (aside from periodic solution changes and skimmer collection cup or filter cleaning), requiring neither drains nor other types of cumbersome water hookups, or outlets, and so may be used in non-industrial environments such as the office or classroom.

Alternative Embodiment

The system and method previously described need not be limited to removing support materials from SFF articles. In an alternative embodiment, the system and method taught herein may be used to remove support material from objects produced by methods other than solid freeform fabrication. In one exemplary embodiment, the system and method described above are used in the production of optical lenses to remove support material from lens materials after grinding.

Lenses for glasses, binoculars, telescopes, and other optical devices are traditionally made by taking a lens blank made of glass, polycarbonate, dietheylene glycol bisallyl carbonate (CR-39), or another optical material and “blocking” the lens blank (attaching it to a metal block using a mixture of paraffin waxes). The lens blank is then cut, ground, and polished to predetermined dimensions appropriate to its application by machinery that uses the metal block to handle and position the lens relative to grinding tools. When the cutting, grinding, and polishing processes are complete the lens blank is called a lens and the metal block and wax must be removed from the lens. Removal of the metal block and wax adhesive may be automated by introducing the lens, metal block, and wax into the present system and subjecting the same to the method taught herein.

The preceding description has been presented only to illustrate and describe embodiments of the present system and method. It is not intended to be exhaustive or to limit the invention to any precise form disclosed. Many modifications and variations are possible in light of the above teaching. It is intended that the scope of the invention be defined by the following claims.

1. A system for separating materials of differing melting points comprising:
an ultrasonic bath including a solution configured to remove a meltable material by cavitation; and
an emulsifier disposed in said solution, wherein said emulsifier is configured to solubilize said meltable material thereby extending a useable life of said solution.

2. The system of claim 1, wherein said materials of differing melting points comprise a solid freeform fabricated (SFF) article.

3. The system of claim 1, further comprising a skimming device configured to remove said meltable material from said solution.

4. The system of claim 3, wherein said skimming device comprises one of a belt, a disk, a drum, a mop, a tube, a floating suction, a columnar, a co-current, a counter current, or a venturi technology skimmer.

5. The system of claim 1, wherein said ultrasonic bath further comprises:
a hot solvent bath; and
an ultrasonic transducer.

6. The system of claim 1, wherein said ultrasonic bath comprises:
a dry oven; and
a hot water bath including an ultrasonic transducer.

7. The system of claim 1, further comprising a computing device coupled to said system.

8. The system of claim 7, wherein said computing device is configured to control a removal of a support material from an SFF article using said system.

9. The system of claim 8, further comprising conveyer belts or robotic arms configured to manipulate said SFF article while in said system.

10. The system of claim 9, wherein said system automated.

11. The system of claim 1, wherein said system is disposed within a solid freeform fabrication system.

12. A method for removing support material from a solid freeform fabricated article comprising:
applying thermal energy to said support material;
cavitating a solution around said support material in an ultrasonic bath thereby suspending a portion of said support material; and
solubilizing said suspended support material with an emulsifier.

13. The method of claim 12, further comprising skimming said suspended support material from said ultrasonic bath with a skimmer.

14. The method of claim 13, wherein said skimmer comprises one of a belt, a disk, a drum, a mop, a tube, a floating suction, a columnar, a co-current, a counter current, or a venturi technology skimmer.

15. The method of claim 12, further comprising melting said support material.

16. The method of claim 13, further comprising controlling said method in response to a number of system computations.

17. The method of claim 16, wherein said system computations aid or entirely regulate a decision making processes for controllably removing said support material.

18. The method of claim 12, wherein said method is performed by an SFF system.

19. The method of claim 12 wherein said applying thermal energy occurs in a first structure and said cavitating a solution around said support material occurs in a second structure.

20. The method of claim 18, further comprising:
removing bubbles from a surface of said solid freeform fabricated article; and
inducing a substantially full wetting condition on said solid freeform fabricated article.

21. A system for removing support material from a solid freeform fabricated article comprising:
a bath;
a cavitation means for inducing cavitation in said bath, said cavitation being configured to remove and suspend said support material; and
an emulsification means for emulsifying said suspended support material.

22. The system of claim 21, further comprising:
a skimming means for skimming said suspended support material from said bath.

23. The system of claim 22, wherein said skimming means comprises one of a belt, a disk, a drum, a mop, a tube, a floating suction, a columnar, a co-current, a counter current, or a venturi technology skimmer.

24. The system of claim 21, further comprising a melting means for melting a support material in a hot water bath.

25. The system of claim 21, wherein said cavitation means comprises an ultrasonic transducer.

26. The system of claim 21, further comprising a calculation means for regulating operation of said system.

27. The system of claim 26, wherein said calculation means comprises a computer.

28. The system of claim 27, further comprising manipulation means for manipulating an SFF article.

29. The system of claim 28, further comprising automation means for automating said system.

30. The system of claim 21, wherein said system forms a part of an SFF system.

31. The system of claim 21, further comprising wetting means for rotating, vibrating, or otherwise manipulating said SFF article.
